(19) United States
(12) Patent Application Publication
(10) Pub. No.: US 2026/0034849 A1
(43) Pub. Date: Feb. 5, 2026

(54) BLOWER MOTOR FOR VEHICLE

(71) Applicant: ILJIN GLOBAL HOLDINGS CO., LTD., Seoul (KR)

(72) Inventors: Woon Ju LEE, Seoul (KR); Jai Seong CHO, Seoul (KR); Ki Chang SHIM, Seoul (KR); Sung Dong CHANG, Seoul (KR); Young Jun HAHM, Seoul (KR)

(73) Assignee: ILJIN GLOBAL HOLDINGS CO., LTD., Seoul (KR)

(21) Appl. No.: 19/354,946

(22) Filed: Oct. 10, 2025

Related U.S. Application Data
(63) Continuation of application No. PCT/KR2024/004791, filed on Apr. 11, 2024.

(30) Foreign Application Priority Data
Apr. 12, 2023 (KR) 10-2023-0048447
Apr. 12, 2023 (KR) 10-2023-0048451
Apr. 12, 2023 (KR) 10-2023-0048452
Apr. 12, 2023 (KR) 10-2023-0048454
Aug. 18, 2023 (KR) 10-2023-0108504

(51) Int. Cl. B60H 1/00; H02K 5/22; H02K 11/33

(52) U.S. Cl. CPC B60H 1/00428; H02K 5/225; H02K 11/33

(57) ABSTRACT

A blower motor for a vehicle includes: a rotor module and a stator module; a lower housing on which the rotor module and the stator module are mounted; a PCB board mounted on a lower surface of the lower housing; a stator phase terminal protruding downward from the stator module and supplying electricity to the stator module; and a PCB terminal coupled to at least a portion of the stator phase terminal to supply power to the stator module. The PCB terminal is formed by bending a single plate into a “U” shape.

### CROSS-REFERENCE TO RELATED APPLICATIONS

This application is a continuation of International Application No. PCT/KR2024/004791 filed on Apr. 11, 2024, which claims priority to Korean Patent Application No. 10-2023-0048447 filed on Apr. 12, 2023, Korean Patent Application No. 10-2023-0048451 filed on Apr. 12, 2023, Korean Patent Application No. 10-2023-0048452 filed on Apr. 12, 2023, Korean Patent Application No. 10-2023-0048454 filed on Apr. 12, 2023, and Korean Patent Application No. 10-2023-0108504 filed on Aug. 18, 2023, the entire contents of which are herein incorporated by reference.

### TECHNICAL FIELD

The present invention relates to a blower motor for a vehicle, and more particularly, to a blower motor for a vehicle having improved electrical connection structure and heat radiation structure of a PCB board.

### BACKGROUND ART

An air conditioning system of a vehicle may include a heater to warm the interior of the vehicle, an air conditioner to cool the interior air, or the like. When the air conditioner or the heater is in operation, the air conditioning system may operate by blowing cooled or heated air into the interior of the vehicle. This blowing may be accomplished through a blower motor.

Typically, a blower motor sucks in outside air and delivers the outside air to the interior of the vehicle, thereby creating ventilation. This intake of the outside air may be achieved by driving the blower motor to rotate a fan.

Recently, BLDC-type motors have been adopted for these blower motors, and in these BLDC-type motors, typically PCB boards are installed inside motor bodies.

Conventional BLDC-type blower motors are configured to supply electricity to the stator by either directly connecting stator phase terminals to the PCB boards or by inserting and fixing them to the PCB terminals on the PCB boards.

However, when the stators are directly connected to the PCB boards, external shocks or vibrations generated during motor operation may cause short circuits, potentially leading to motor failure. Furthermore, the contact structure between the PCB terminals installed on the PCB boards and the stator phase terminals also carries the risk of poor contact. Furthermore, the PCB boards, including electrical components and generating significant heat, requires efficient heat radiation. However, ensuring both electrical insulation and heat radiation performance is difficult, and the complex structure required to achieve this often increases manufacturing costs.

### SUMMARY

### Technical Problem

The present invention is devised to solve the above-described problems of the related art, and an object of the present invention is to provide a blower motor for a vehicle in which electrical connection structure and heat radiation structure of a PCB board are improved.

### Technical Solution

A blower motor for a vehicle 1 according to one embodiment of the present invention includes: a rotor module 230 and a stator module 220; a lower housing 210 on which the rotor module 230 and the stator module 220 are mounted; a PCB board 500 mounted on a lower surface of the lower housing 210; a stator phase terminal 226 protruding downward from the stator module 220 and supplying electricity to the stator module 220; and a PCB terminal 600 coupled to at least a portion of the stator phase terminal 226 to supply power to the stator module 220, wherein the PCB terminal 600 is formed by bending a single plate into a “U” shape.

Also, according to one embodiment, the PCB terminal 600 may include a first frame 620, a second frame 640, and a connecting frame 660 connecting the first frame and the second frame, and each of the first frame and the second frame may include a clamp portion 623 including a first bending portion 621 and a second bending portion 622 to elastically clamp the PCB board 500.

A portion of the stator phase terminal 226 may be inserted into a predetermined gap formed by the first frame 620 and the second frame 640 and may be configured to be fitted between the first frame 620 and the second frame 640.

Furthermore, according to one embodiment, each of the first frame 620 and the second frame 640 may include a third bending portion 624, and each of the first frame 620 and the second frame 640 may have a first inclined extension portion 625 that is formed to approach each other as it extends downward from the third bending portion 624 so that the stator phase terminal 226 is fitted in a state of being elastically pressed by the first frame and the second frame.

Each of the first frame 620 and the second frame 640 may include a fourth bending portion 626, and each of the first frame 620 and the second frame 640 may include a second inclined extension portion 627 that is formed to extend away from each other as it extends downward from the fourth bending portion 626.

Moreover, each of the first frame 620 and the second frame 640 may include a fourth bending portion 626, and the fourth bending portions of the first frame 620 and the second frame 640 may be formed to face each other so that a portion of the stator phase terminal 226 is fitted between the fourth bending portions.

According to one embodiment of the present invention, the blower motor for a vehicle may further include a double-sided adhesive tape 700 disposed between the PCB board 500 and the lower surface of the lower housing 210 to attach the PCB board 500 to the lower surface of the lower housing 210. The double-sided adhesive tape 700 may be formed of an electrically insulating and heat-conducting material.

The rotor module 230 and the stator module 220 may be in contact with the lower housing 210, the lower housing 210 is in contact with a flange coupled to the body, and the lower housing 210 may be configured to function as a heat sink for the rotor module 230, the stator module 220, and the PCB board 500.

Also, each of the lower housing 210 and the double-sided adhesive tape 700 may include a through hole 214 or 710 for the stator phase terminal 226 to extend therethrough.

### Advantageous Effects

According to one embodiment of the present invention, a PCB terminal is formed by bending a single plate into a “U” shape, and the PCB terminal is elastically supported and maintained in contact with a stator phase terminal through the interaction of at least one bending portion, thereby reducing the risk of poor contact between the PCB terminal and the stator phase terminal.

Furthermore, according to one embodiment of the present invention, a PCB board can be mounted on a lower housing with a simple structure, and the heat radiation performance of the PCB board can be improved.

### DESCRIPTION OF DRAWINGS

FIG. 1 is a perspective view of a blower motor according to an embodiment of the present invention.

FIG. 2 is an exploded perspective view of the blower motor shown in FIG. 1.

FIG. 3 is an exploded perspective view of a motor module shown in FIG. 2.

FIG. 4 is a view showing the combination of a stator phase terminal and a PCB terminal according to one embodiment of the present invention.

FIG. 5 is an enlarged view of the circled region in FIG. 4.

FIG. 6 is a perspective view of the PCB terminal according to one embodiment of the present invention.

FIG. 7 is a view for describing a configuration in which a PCB board is coupled to a lower housing.

### DETAILED DESCRIPTION

The advantages and features of the present invention, and the methods for achieving them, will become clearer with reference to the embodiments described in detail below together with the accompanying drawings. However, the present invention is not limited to the embodiments disclosed below, but may be implemented in various different forms. The present embodiments are provided only to ensure that the disclosure of the present invention is complete and to fully inform those skilled in the art of the present invention of the scope of the invention, and the present invention is defined only by the scope of the claims. The same reference numerals refer to like elements throughout the specification.

When an element is referred to as being “above” or “on” another element, it includes not only being directly on the other element, but also having other elements intervening therewith. Conversely, when an element is referred to as being “directly on” or “just above,” it indicates that there are no intervening elements. “And/or” includes each and every combination of one or more of the mentioned items.

Spatially relative terms such as “below,” “beneath,” “lower,” “above,” and “upper” may be used to easily describe the relationship between one component and another, as shown in the drawings. Spatially relative terms should be understood to include different orientations of the element during use or operation in addition to the orientations shown in the drawings. The same reference numerals throughout the specification refer to the same components.

Although the terms first, second, and the like are used to describe various components and/or sections, these components and/or sections are not limited by these terms. These terms are merely used to distinguish one component or section from another. Accordingly, it should be understood that a first component or a first section referred to below may also be a second component or a second section within the technical concept of the present invention.

The embodiments described in the present specification will be described with reference to plan views and cross-sectional views, which are ideal schematic drawings of the present invention. Accordingly, the shapes of the illustrated drawings may be modified due to manufacturing techniques and/or tolerances. Accordingly, the embodiments of the present invention are not limited to the specific shapes illustrated, but also include changes in shapes resulting from the manufacturing process. Accordingly, the regions shown in the drawings have schematic properties, and the shapes of the regions shown in the drawings are intended to illustrate specific shapes of regions of the configuration, and are not intended to limit the scope of the invention.

Hereinafter, a preferred embodiment of the present invention will be described in more detail with reference to the attached drawings.

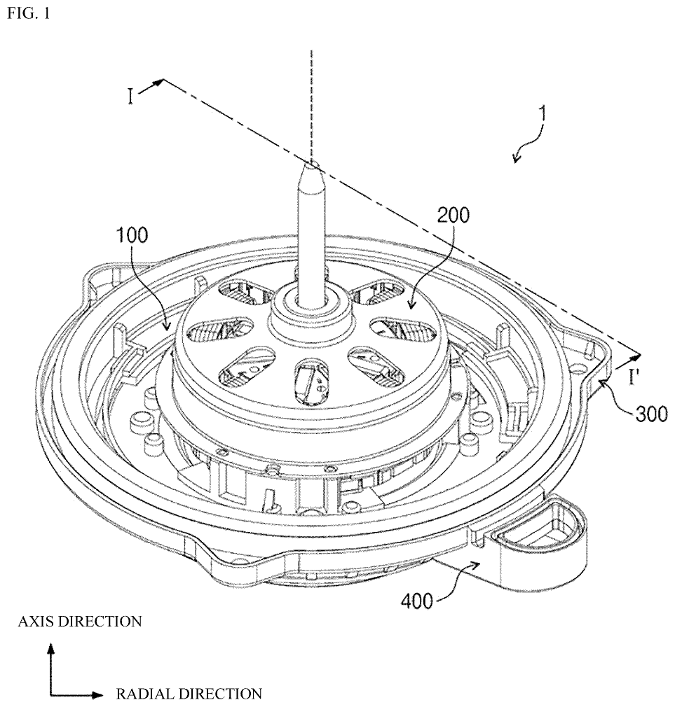

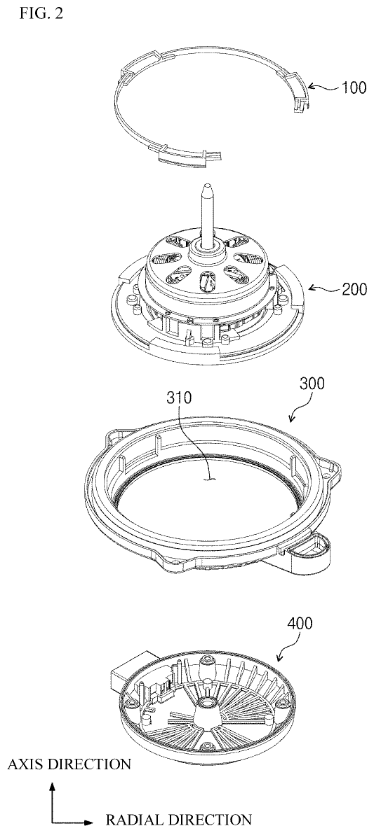

FIG. 1 is a perspective view of a blower motor according to an embodiment of the present invention. FIG. 2 is an exploded perspective view of the blower motor shown in FIG. 1.

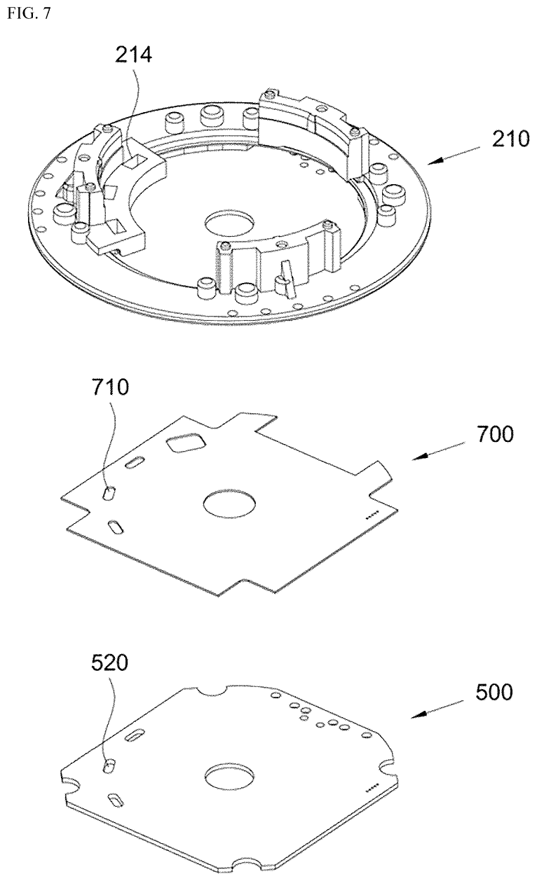

Referring to FIGS. 1 and 2, a blower motor 1 may include a clamp 100, a motor module 200, a flange 300, a cover 400, and a PCB board 500 (for a PCB board, see FIG. 7). The clamp 100 is a component that fixes the motor module 200 to the flange 300 and may be, for example, in a ring shape with a portion omitted in a circumferential direction. First, the motor module 200 will be described as follows.

### 1. Motor Module

The motor module 200 is a module that receives electrical energy and drives a motor (more specifically, a rotor) to rotate a cooling wheel (not shown) to generate air flow.

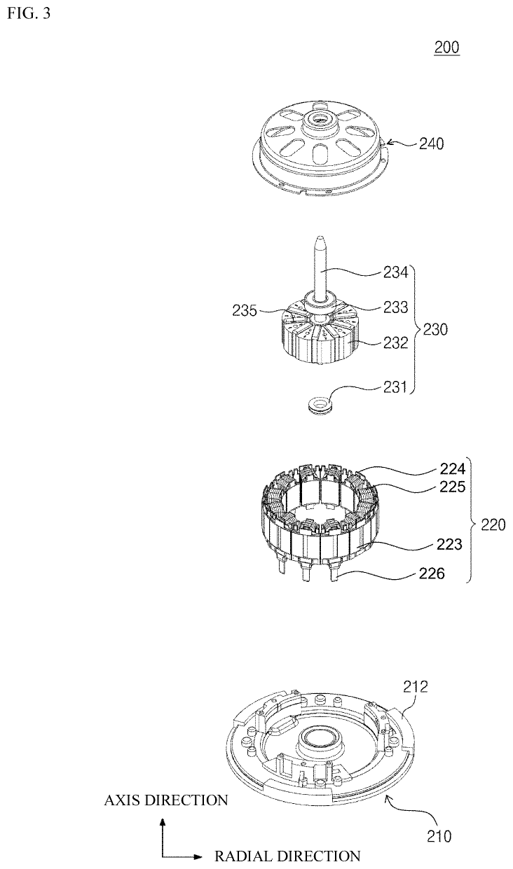

FIG. 3 is an exploded perspective view of the motor module shown in FIG. 2. Referring to FIG. 3, the motor module 200 according to one embodiment of the present invention may include a lower housing 210, a stator module 220, a rotor module 230, and an upper housing 240.

First, the rotor module 230 includes a shaft 234, a rotor 232 that is press-fitted and fixed to the shaft 234, a first bearing 231 that is press-fitted and fixed to the shaft 234 to form an axis center and perform a function of reducing rotational resistance, and a second bearing 233.

The rotor 232 may be formed in a cylindrical shape and may be implemented with a structure in which a plurality of magnets 235 are inserted therein. For example, each of the magnets 235 may be a permanent magnet with a rectangular structure and has a function of generating magnetic flux.

Subsequently, the stator module 220, which is one of components of the motor module 200, is a module for electromagnetically rotating the rotor 232 and may include, for example, a stator core 223, an insulator 224, a coil 225, and a stator phase terminal 226.

The stator core 223 may be formed to have a hollow cylindrical shape so that the rotor 232 is disposed therein and may have a structure in which the coil 225 is wound. The insulator 224 is a structure for electrical insulation between the stator core 223 and the coil 225 and for connection between the stator core 223 and the stator phase terminal 226.

The coil 225 is electrically connected to the PCB board through the stator phase terminal 226, through which electricity flows through the coil 225, and the coil 225 is wound around the stator core 223 to electromagnetically rotate the rotor 232.

Subsequently, the lower housing 210 is a component that covers lower portions of the rotor module 230 and the stator module 220, and the upper housing 240 is a component that covers upper portions of the rotor module 230 and the stator module 220. The housing damper 212 may additionally be installed in the lower housing 210.

According to one embodiment of the present invention, the motor module 200 may be assembled by arranging the rotor module 230 and the stator module 220 on the lower housing 210 and finally coupling the upper housing 240 to the lower housing 210.

### 2. PCB Terminal

The PCB board is a component that is formed in a plate shape and has a plurality of electronic components installed on the board to control and supply power to the stator module.

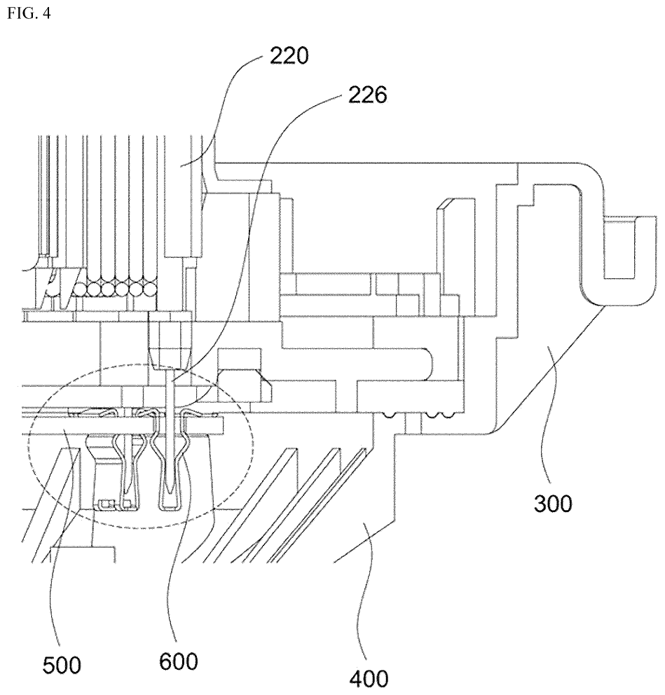

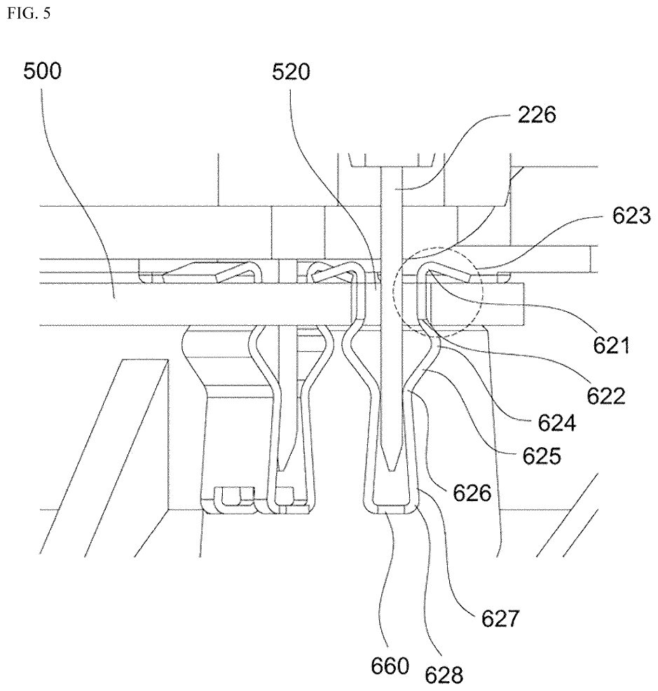

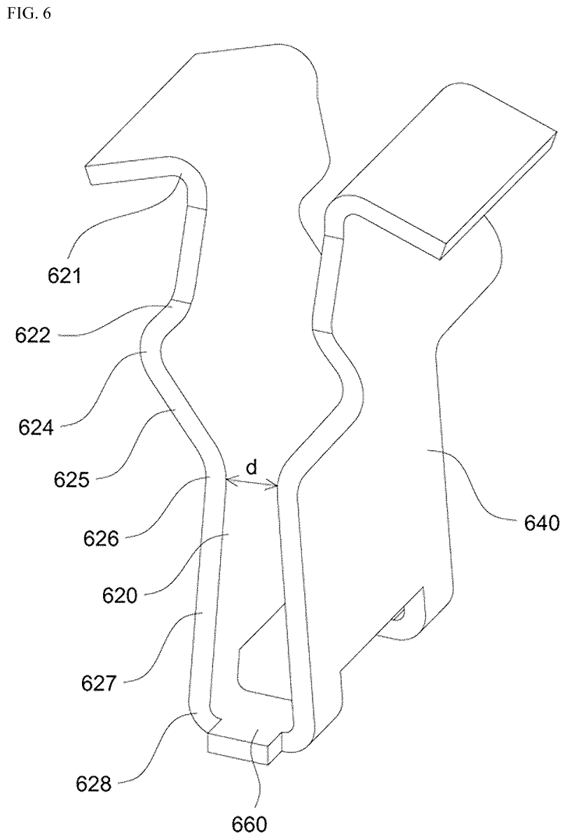

FIG. 4 is a view showing the combination of the stator phase terminal and the PCB terminal according to one embodiment of the present invention. FIG. 5 is an enlarged view of the circled region in FIG. 4. FIG. 6 is a perspective view of the PCB terminal according to one embodiment of the present invention. FIG. 7 is a view for describing a configuration in which the PCB board is coupled to the lower housing. The following description will be made with reference to FIGS. 4 to 7.

According to one embodiment of the present invention, the PCB board 500 may be installed in an internal space defined by the lower housing 210 and the cover 400, and is preferably mounted on a lower surface of the lower housing 210.

The lower housing 210 may be provided with a through hole 214 through which the above-described stator phase terminal 226 of the stator module 220 extends. Through this, when the stator module 220 is mounted on the lower housing 210, the stator phase terminal 226 may extend to pass through the through hole 214 and may be in contact with the PCB terminal 600 installed to electrically connect to the PCB board 500. The stator module 220 may be electrically connected by the contact between the stator phase terminal 226 and the PCB terminal 600.

According to one embodiment of the present invention, as shown in FIGS. 5 and 6, the PCB terminal 600 may be formed by bending a single plate into a “U” shape. More specifically, the PCB terminal 600 may include a first frame 620, a second frame 640, and a connecting frame 660 connecting the first frame 620 and the second frame 640.

As shown in FIGS. 5 and 6, each of the first frame 620 and the second frame 640 may include a first bending portion 621 and a second bending portion 622, and a clamp portion 623 that elastically clamps the PCB board 500. Through the above-described configuration, the PCB terminal 600 may be fixed in place simply by inserting the PCB terminal 600 into the through hole 520 of the PCB board 500 without welding or additional fixing elements.

A portion of the stator phase terminal 226 may be inserted into a predetermined gap d formed by the first frame 620 and the second frame 640 and may be disposed between the first frame 620 and the second frame 640. For this purpose, for example, each of the first frame 620 and the second frame 640 may include a third bending portion 624. Each of the first frame 620 and the second frame 640 may include a first inclined extension portion 625 that extends downward from the third bending portion 624 and becomes closer to each other, thereby allowing the stator phase terminal 226 to be elastically pressed into the first frame 620 and the second frame 640.

Furthermore, each of the first frame 620 and the second frame 640 may include a fourth bending portion 626. For example, the fourth bending portion 626 of the first frame 620 and the second frame 640 may be formed to face each other so that a portion of the stator phase terminal 226 is fitted between the fourth bending portion 626.

Additionally, each of the first frame 620 and the second frame 640 may be formed to include a second inclined extension portion 627 that extends downward from the fourth bending portion 626 and becomes further spaced apart from each other. Ends of the second inclined extension portions 627 of the first frame 620 and the second frame 640 may be connected by the connecting frame 660. As described above, the PCB terminal 600 is a component formed by bending a single plate, and the portion where the second inclined extension portions 627 of the first frame 620 and the second frame 640 are connected by the connecting frame 660 may be implemented as a fifth bending portion 628.

In this way, the PCB terminal 600 may be configured to include the first bending portion 621, the second bending portion 622, the third bending portion 624, the fourth bending portion 626, and the fifth bending portion 628, and all of these bending portions serve to elastically support the stator phase terminal 226 into which the PCB terminal 600 is inserted while helping to maintain contact with the stator phase terminal 226. Accordingly, in the present invention, the risk of poor contact occurring between the PCB terminal 600 and the stator phase terminal 226 may be reduced.

### 3. PCB Board Bonding Structure and Heat Radiation Structure

FIG. 7 is a view for describing a configuration in which the PCB board is bonded to the lower housing. As shown in FIG. 7, according to one embodiment of the present invention, a double-sided adhesive tape 700 may be disposed between the PCB board 500 and the lower surface of the lower housing 210. Accordingly, the PCB board 500 may be attached to the lower surface of the lower housing 210 by the double-sided adhesive tape 700. The double-sided adhesive tape 700 may be formed of an electrically insulating and thermally conductive material. For example, the double-sided adhesive tape may be made of polyethylene terephthalate (PET). A through hole 710 through which the stator phase terminal 226 passes may be formed in the double-sided adhesive tape 700.

As described above, the rotor module 230 and the stator module 220 may be mounted on an upper surface of the lower housing 210 and may come into contact with the upper surface of the lower housing 210, and the PCB board 500 may be mounted on the lower surface of the lower housing 210 using the double-sided adhesive tape 700 of a heat-conductive material so that the lower housing 210 functions as a heat sink for the rotor module 230, the stator module 220, and the PCB board 500.

In addition, as an exemplary embodiment, the blower motor 1 for a vehicle according to one embodiment of the present invention may further include the flange 300. The flange 300 is a component for accommodating the motor module 200 and connecting the motor module 200 to, for example, a duct of an air conditioning system. The flange 300 may be formed in a ring shape so that at least a portion of the motor module 200 is disposed inside the flange 300. For example, a through hole 310 may be formed at a center of the flange 300, the through hole 310 of the flange 300 may have a circular shape, and the motor module 200 may be disposed and fixed in the through hole 310 of the flange 300 in such a way that the lower housing of the motor module 200 is coupled to an inner circumferential surface of the through hole 310 of the flange 300. Accordingly, heat generated in the rotor module 230, the stator module 220, and the PCB board 500 may be discharged to the outside of the motor through the lower housing 210 functioning as a heat sink and the flange 300 coupled thereto so that the heat radiation performance of the blower motor 1 for a vehicle may be improved.

Although the present invention has been described with reference to the above embodiments, it will be understood by those skilled in the art that various modifications and changes can be made to the present invention without departing from the spirit and scope of the present invention as set forth in the claims below. In addition, the embodiments disclosed in the present invention are not intended to limit the technical idea of the present invention, and all technical ideas within the scope of the following claims and equivalents thereof should be interpreted as being included within the scope of the rights of the present invention.

What is claimed is:

1. A blower motor (1) for a vehicle, comprising:
a rotor module (230) and a stator module (220);
a lower housing (210) on which the rotor module (230) and the stator module (220) are mounted;
a PCB board (500) mounted on a lower surface of the lower housing (210);
a stator phase terminal (226) protruding downward from the stator module (220) and supplying electricity to the stator module (220); and
a PCB terminal (600) coupled to at least a portion of the stator phase terminal (226) to supply power to the stator module (220),
wherein the PCB terminal (600) is formed by bending a single plate into a “U” shape.

2. The blower motor (1) for a vehicle of claim 1, wherein the PCB terminal (600) includes a first frame (620), a second frame (640), and a connecting frame (660) connecting the first frame and the second frame, and
each of the first frame and the second frame includes a clamp portion (623) including a first bending portion (621) and a second bending portion (622) to elastically clamp the PCB board (500).

3. The blower motor (1) for a vehicle of claim 2, wherein a portion of the stator phase terminal (226) is inserted into a predetermined gap formed by the first frame (620) and the second frame (640) and is configured to be fitted between the first frame (620) and the second frame (640).

4. The blower motor (1) for a vehicle of claim 2, wherein each of the first frame (620) and the second frame (640) includes a third bending portion (624), and each of the first frame (620) and the second frame (640) has a first inclined extension portion (625) that is formed to approach each other as it extends downward from the third bending portion (624) so that the stator phase terminal (226) is fitted in a state of being elastically pressed by the first frame and the second frame.

5. The blower motor (1) for a vehicle of claim 4, wherein each of the first frame (620) and the second frame (640) includes a fourth bending portion (626), and each of the first frame (620) and the second frame (640) includes a second inclined extension portion (627) that is formed to extend away from each other as it extends downward from the fourth bending portion (626).

6. The blower motor (1) for a vehicle of claim 4, wherein each of the first frame (620) and the second frame (640) includes a fourth bending portion (626), and the fourth bending portions of the first frame (620) and the second frame (640) are formed to face each other so that a portion of the stator phase terminal (226) is fitted between the fourth bending portions.

7. The blower motor (1) for a vehicle of claim 1, further comprising a double-sided adhesive tape (700) disposed between the PCB board (500) and the lower surface of the lower housing (210) to attach the PCB board (500) to the lower surface of the lower housing (210),
wherein the double-sided adhesive tape (700) is formed of an electrically insulating and heat-conducting material.

8. The blower motor (1) for a vehicle of claim 7, wherein the rotor module (230) and the stator module (220) are in contact with the lower housing (210),
the lower housing (210) is in contact with a flange coupled to a body, and
the lower housing (210) is configured to function as a heat sink for the rotor module (230), the stator module (220), and the PCB board (500).

9. The blower motor (1) for a vehicle of claim 7, wherein each of the lower housing (210) and the double-sided adhesive tape (700) includes a through hole (214 or 710) for the stator phase terminal (226) to extend therethrough.
